(19) United States
(12) Patent Application Publication
(10) Pub. No.: US 2005/0013611 A1
(43) Pub. Date: Jan. 20, 2005

(54) Image data processing apparatus in optical subscriber network

(76) Inventors: Chang-Hyun Lee, Suwon-shi (KR); Chan-Yul Kim, Puchon-shi (KR); Sang-Ho Kim, Suwon-shi (KR); Jun-Ho Koh, Suwon-shi (KR)

Correspondence Address: CHA & REITER, LLC, 210 ROUTE 4 EAST STE 103, PARAMUS, NJ, 07652, US

(21) Appl. No.: 10/763,985

(22) Filed: Jan. 23, 2004

(30) Foreign Application Priority Data
Jul. 16, 2003 (KR) 2003-48926

(51) Int. Cl. H04J 14/00

(52) U.S. Cl. 398/51

(57) ABSTRACT

An image data transmission apparatus in an optical subscriber network is disclosed, which comprises: one optical line termination for receiving MPTS data from an outside, packetizing the received MPTS data into HDLC packets, and transmitting the HDLC packets as optical signals; and a plurality of ONUs connected to the OLT, the ONU receiving the optical signal transmitted from the OLT, converting the optical signal into an electrical signal, extracting MPTS data from the converted HDLC packet, and switching the MPTS data to each subscriber. The image data transmission apparatus processes HDLC-based MPTS data, increases degree of integration of data, and therefore enables the optical subscriber network to include more channels.

### CLAIM OF PRIORITY

This application claims priority to an application entitled “Image data processing apparatus in optical subscriber network,” filed in the Korean Intellectual Property Office on Jul. 16, 2003 and assigned Serial No. 2003-48926, the contents of which are hereby incorporated by reference.

### BACKGROUND OF THE INVENTION

1. Field of the Invention

The present invention relates to image information transmission in an optical communication network, and more particularly to image information transmission in an active optical network (AON).

2. Description of the Related Art

Recently, researchers have pursued the development of networks that have the capability of data transmission in the Gigabit range. Along with this network research, broadcasting service using such a network have also been considered. In particular, high definition broadcast transmission (hereinafter, referred to as HD). High speed networks, such as an optical subscriber network, have been continuously demanded by digital broadcasting service providers. Disadvantageously, both, an asymmetric digital subscriber line (ADSL) of about 10 Mbps and a very high-data rate digital subscriber line (VDSL) with a 50 Mbps grade have limitations in transmitting high definition broadcasts.

The digital broadcasting service can not only provide broadcasting but also various other services such as a video on demand (VOD) or interactive broadcasting service. Users have also demanded such services. In order to meet these demands, an open cable standard has been established and commercialization efforts with fiber to the home (FTTH) are becoming more active. Such FTTH networks are capable of performing rapid communication and are optical subscriber networks.

In an active optical network (AON)-based FTTH, which satisfies such requirements, ATM-based moving picture experts group (MPEG) data is transmitted through a synchronous optical network (SONET) and a synchronous digital hierarchy (SDH) is proposed. Accordingly, it is possible to include 64 HD broadcasting channels in a synchronous transport module (hereinafter, referred to as STM)-16. Generally, in a passive optical network (PON), one optical line termination (hereinafter, referred to as OLT) is connected to a plurality of optical network units (hereinafter, referred to as ONUs) using an optical distribution network (hereinafter, referred to as ODN) of 1 by N. This configuration forming a distributed topology with a tree structure. The AON differs from the PON. Particularly, the AON requires an active device since an ONU terminal must be subjected to a signal processing in the AON.

FIG. 1 is a block diagram showing of an OLT for a conventional ATM-based image information transmission.

As shown in FIG. 1, the OLT 100 for a conventional ATM-based image information transmission includes: an ATM (asynchronous transfer mode) cell processing section 11 for (1) receiving a multi-program transmission stream (hereinafter, referred to as MPTS) data from an outside image source, (2) converting the MPTS data into an ATM cell and (3) outputting the converted ATM cell; 16 STM-1 framers 12 for converting the ATM cell into a STM-1 optical signal for an optical transmission; and a STM-16 framer 13 for converting the signals from the 16 STM-1 framers 12 into a STM-16 optical signal, which is a wideband signal.

The image information that is converted into the STM-16 optical signal is provided to each subscriber through a reverse process performed by an ONU 200.

When an image is transmitted using the ATM cell, as described above, the line transmission rate of the STM-1 is 155.520 Mbps and a transmission rate of a SONET payload excluding an overhead of an optical signal is 149.760 Mbps (this is information provided from http://sd.wareonearth.com/˜phil/net/overhead/).

However, when an ATM cell is used, the transmission rate of an ATM payload (48 byte) is only 135.632 Mbps due to overhead (5 byte) of the ATM cell (53 byte). Consequently, for transmission using the ATM cell, 5 bytes per 53 bytes are assigned to the overhead with no relation to the data, thereby wasting bandwidth.

Accordingly, the overhead of the ATM cell causes about a 10% reduction in the transmission rate. This is the result in the STM-1. However, the STM-16 shows a reduction of 226 Mbps (computed by (149.760−135.632)×16) in the transmission rate. Such a reduction in the transmission rate implies a loss to such a degree as to provide at least eight channels of 27 Mbps HD images. Accordingly, there is a need for an image data transmission apparatus that can prevent the transmission rate degradation due to such an ATM cell.

Further, the conventional ONU 200 includes 64 HD channels in the STM-16 using an ATM-based MPEG data transmission method through the SONET. The ONU 200 selects two channels by switching MPTS data in the 64 received channels according to the requirements of the subscribers and transmits the selected channels to each subscriber. A physical switching apparatus is used to switch and transmit the received MPTS data to the subscribers included in the ONU 200. However, the physical switching apparatus has a fixed number of inputs and outputs (N by M). Thus, it has limited adaptability and/or expansibility when the number of subscribers in the ONU 200 changes.

### SUMMARY OF THE INVENTION

Accordingly, the present invention has been made to reduce or overcome the above-mentioned limitations occurring in the prior art. One object of the present invention is to provide an image data processing apparatus for use in an optical subscriber network, which processes HDLC-based MPTS data and thus increases degree of integration of data, and which enables the optical subscriber network to include more channels.

Another object of the present invention is to provide an image data processing apparatus in an optical subscriber network, which performs switching by means of a memory, thereby enabling image information transmission having a high adaptability to variation in the number of transmission channels or subscribers.

In order to accomplish the aforementioned objects, according to an embodiment of the present, there is provided an image data transmission apparatus in an optical subscriber network comprising: one OLT for receiving MPTS data from an outside, packetizing the received MPTS data into HDLC packets, and transmitting the HDLC packets as optical signals; and a plurality of ONUs connected to the OLT, the ONU receiving the optical signal transmitted from the OLT, converting the optical signal into an electrical signal, extracting MPTS data from the converted HDLC packet, and switching the MPTS data to each subscriber.

### BRIEF DESCRIPTION OF THE DRAWINGS

The present invention will be more apparent from the following detailed description taken in conjunction with the accompanying drawings, in which:

FIG. 1 is a block diagram showing an OLT for a conventional ATM-based image information transmission;

FIG. 2 is a block diagram showing an embodiment of an OLT for an HDLC-based image information transmission according to the present invention;

FIG. 3 is a block diagram showing an embodiment of an HDLC packet processing section in an OLT for an HDLC-based image information transmission according to the present invention;

FIG. 4 is a block diagram showing an embodiment of an HDLC packet used in the present invention;

FIG. 5 is a block diagram showing an embodiment of an ONU for the HDLC-based image information transmission according to the present invention;

FIG. 6 is a block diagram showing an embodiment of an HDLC packet processing section in an ONU for the HDLC-based image information transmission according to the present invention; and

FIG. 7 is a block diagram showing an embodiment of a switching apparatus with an expansible ONU according to the present invention.

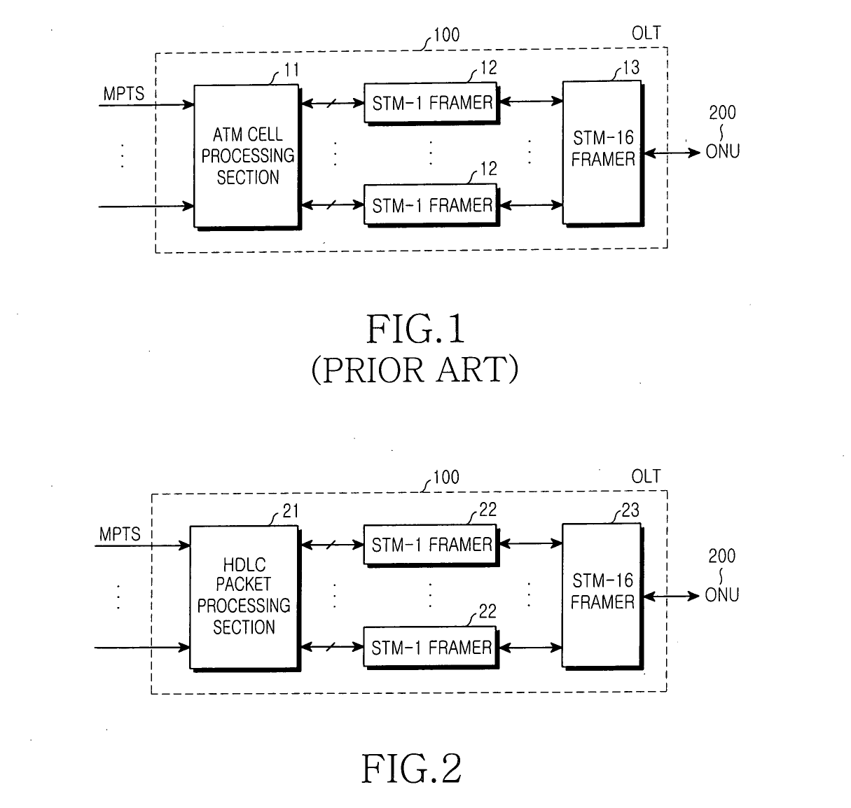

### DETAILED DESCRIPTION OF THE PREFERRED EMBODIMENT

Hereinafter, a preferred embodiment according to the present invention will be described with reference to the accompanying drawings. The same reference numerals are used to designate the same elements as those shown in other drawings. In the following description of the present invention, a detailed description of known functions and configuration incorporated herein will be omitted when it may make the subject matter of the present invention rather unclear.

The MPTS, including image information data, is a data flow that continuously transmitted through a communication line without interruption. Accordingly, the present invention considers that the image information data does not require complex protocol processing. Such complex protocol processing may be required when the sizes of packets change due to discontinuity of inputted data, or when the image information data is processed in the form of packets.

Thus, since it is possible to continuously transmit MPTS data, the MPTS data can be converted into packet data with a predetermined payload, such as an ATM cell, by making the packet have a predetermined size. Therefore, the present invention enables image information transmission according to a high-level data link control procedure (hereinafter, referred to as HDLC) protocol, which has a payload size of 64 to 1024.

FIG. 2 is a block diagram showing an embodiment of an OLT for an HDLC-based image information transmission according to the present invention.

As shown in FIG. 2, the OLT 100 for the HDLC-based image information transmission according to the present invention includes an HDLC packet processing section 21 for (1) receiving a multi-program transmission stream (hereinafter, referred to as MPTS) data from an outside image source, (2) converting the MPTS data into HDLC packets and (3) outputting the converted HDLC packets at a data transmission rate of 51.84 Mbps; 16 STM-1 framers 22 for receiving three HDLC packets of 51.84 Mbps and converting the HDLC packets into STM-1 optical signals of 155.520 Mbps for an optical transmission and a STM-16 framer 23 for converting the signals from the 16 STM-1 framers 12 into a STM-16 optical signal, which is a wideband signal.

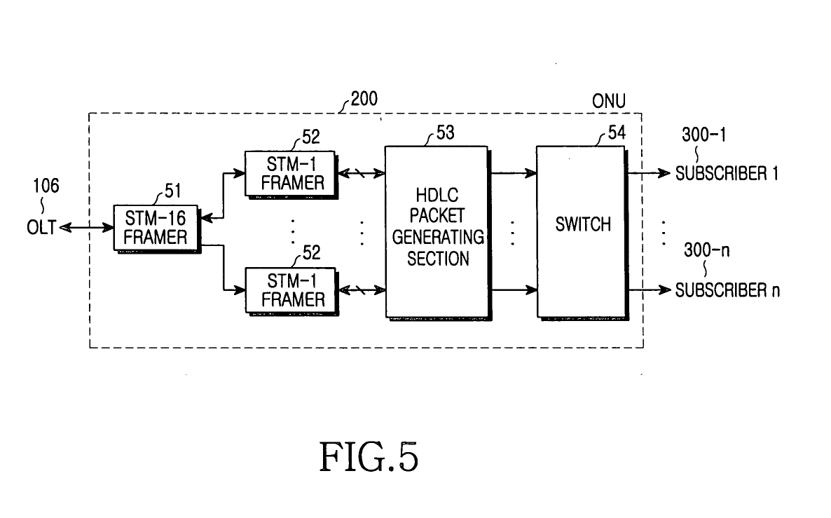

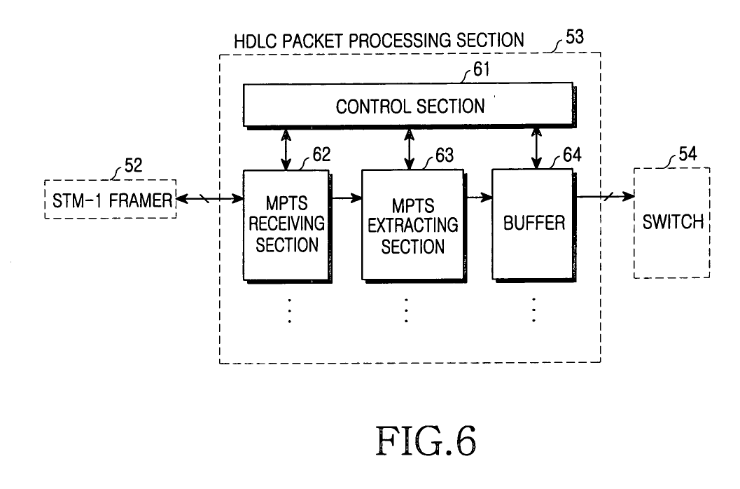

The image information that is converted into the STM-16 optical signal, as described above, is provided to each subscriber through a reverse process performed by an ONU 200. This process is further described in reference to FIGS. 5 to 6.

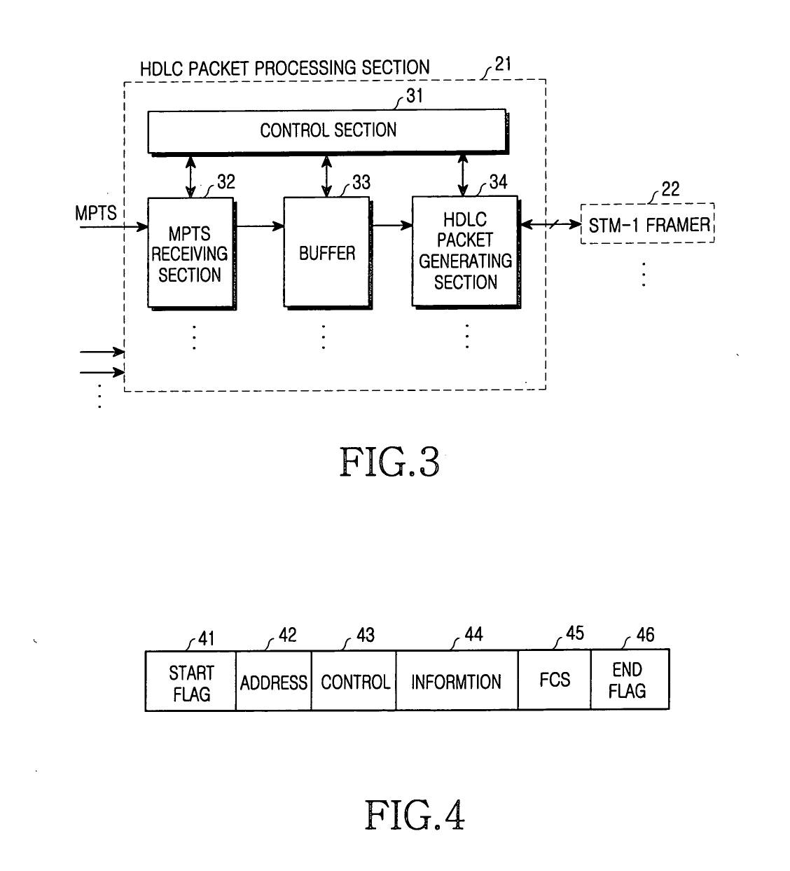

FIG. 3 is a block diagram showing an embodiment of an HDLC packet processing section in an OLT for an HDLC-based image information transmission according to the present invention. The HDLC packet processing section 21 shown in FIG. 3 converts MPTS data according to the present invention into HDCL packets. In this process, unnecessary overhead is reduced in contrast with the conventional ATM method. The HDLC packet processing section 21 also processes the HDCL packet, and includes an MPTS receiving section 32, which is an interface section, for receiving MPTS data. It includes (1) a buffer 33 for buffering the received MPTS data to convert MPTS data into an HDLC packet, (2) an HDLC packet generating section 34 for calling data, which has a predetermined size of 64 byte to 1024 byte, from the buffer 33 and generating a HDCL packet according to a HDCL protocol and (3) a control section 31 for controlling each component.

FIG. 4 is a block diagram showing an embodiment of an HDLC packet used in the present invention.

As shown in FIG. 4, each HDLC packet includes (1) a start flag field 41 for representing a start of the HDLC packet, (2) an end flag field 46 for representing an end of the HDLC packet, (3) an address field 42, which consists of one byte, for recording addresses of a transmission system and a reception system, (4) a control field 43 for representing format control information such as an I format which consists of one byte and is an information transmission frame, an S format which is a frame for link monitor control and a U format which is a frame for expansion, (5) an information field 44 which has a variable length of 64 bytes to 1024 bytes and represents user information and control information interchanged between a transmission terminal and a reception terminal, and (6) a frame check sequence (FCS) field 45 which consists of two bytes and detects an error in a received frame.

An image data transmission according to the present invention is described with reference to FIGS. 2 to 4. In an ATM method transmission, the ratio of overhead (5) with respect to payload (48) is five to forty eight. However, when an HDLC packet according to the present invention is used, the ratio of a overhead with respect to payload is 6/64-1024. Accordingly, selective use is possible. For example, when the information field 44 of the HDLC packet is fixed at 512 bytes, a payload transmission rate of 6:512 is obtained. Therefore unnecessary overhead is reduced by about one tenth in comparison to the ATM transmission method. Further, when the information field 44 of the HDLC packet is commonly fixed and used in a system, ATM cells, or the like, can be used. That is, packet processing equalized to a packet with a predetermined size is possible. Of course, the possibility of such operation is furthered by the fact that the MPTS data is continuously inputted.

FIG. 5 is a block diagram showing an embodiment of an ONU for the HDLC-based image information transmission according to the present invention.

As shown in FIG. 5, the ONU 200 for the HDLC-based image information transmission according to the present invention includes (1) an STM-16 framer 51 for dividing a STM-16 signal into a STM-1 signal, (2) a 16 STM-1 framer 52 for converting the STM-1 signal into an HDLC packet, which is an electrical signal, and outputting the converted signal, (3) an HDLC packet processing section 53 for receiving the HDLC packet from each of the 16 STM-1 framers 52, extracting MPTS data, which is image information, included in each HDLC packet and outputting the extracted MPTS data, and (4) a switch 54 for switching the outputted MPTS data according to requirements of subscribers 300-1 to 300-n.

FIG. 6 is a block diagram showing an embodiment of an HDLC packet processing section in an ONU for the HDLC-based image information transmission according to the present invention.

The HDLC packet processing section 53 shown in FIG. 6 converts an HDLC packet, which has been generated for optical transmission according to the present invention, into MPTS data. The HDLC packet processing section 53 includes (1) an HDLC packet receiving section 62, which is an interface section, for receiving an HDLC packet, (2) an MPTS extracting section 63 for removing an overhead of the HDLC packet and extracting MPTS data, (3) a buffer 64 for buffering the extracted MPTS data so that the MPTS data can be continuously outputted to the switch 54, and (4) a control section 61 for controlling each component.

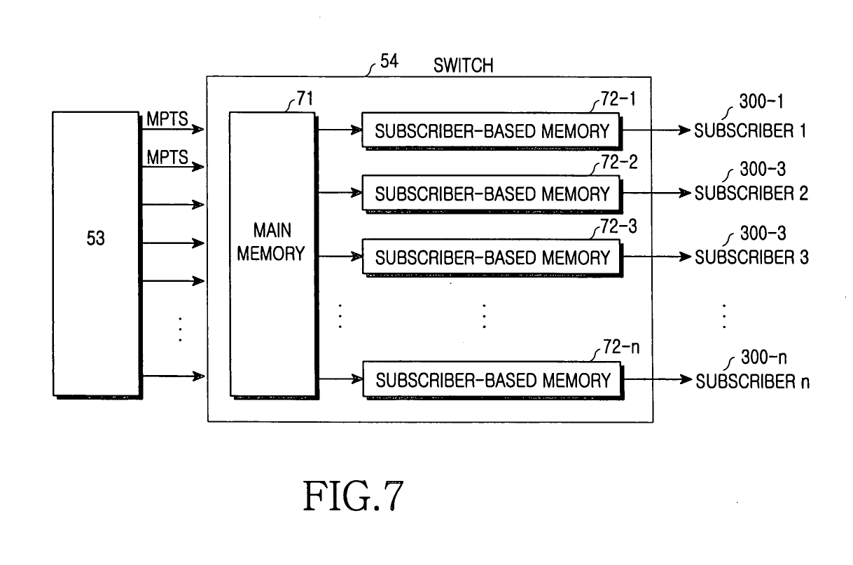

FIG. 7 is a block diagram showing an embodiment of a switching apparatus with an expansible ONU according to the present invention.

The switching operation for image information for respective subscribers' in a conventional ONU is performed using a physical switching apparatus. In contrast, the switching apparatus according to the present invention shown in FIG. 7 performs a switching operation using a memory.

In particular, a plurality of MPTSs data output from the HDLC packet processing section 53 are assigned and stored according to storage areas based on the MPTS data information. The stored MPTS information is transmitted to each of the subscribers 300-1 to 300-n through each of the subscriber-based memories 72-1 to 72-n.

According to one embodiment of the present invention, each of the subscriber-based memories 72-1 to 72-n has a storage capacity capable of storing two image channels.

An area is assigned according to MPTS data inputted to a main memory 71. In order to output a channel required by each of the subscribers 300-1 to 300-n, each of the subscriber-based memories 72-1 to 72-n accesses an address. MPTS data in a channel, required by a subscriber, are assigned to an address. Upon accessing the particular address the stored MPTS data is output.

In this embodiment, the main memory 71 and each of subscriber-based memories 72-1 to 72-n output or discard first-inputted data in a first-in first-out (FIFO) method when data of more than a predetermined amount are filled.

When the above memory based switching operation is performed, the switching apparatus processes the MPTS data by software through area assignation in memory. This occurs even if inputted MPTS data or the number of subscribers, which is an object of an output, changes. Thus, significant improvement in expansibility is achieved, in comparison to the conventional switching apparatus that is constructed in hardware.

In the present invention, the HDLC-based MPTS data is processed, so as to increase the degree of integration of data, thereby enabling more channels in data transmission.

Further, in the present invention, an active optical network apparatus for transmitting image information performs the switching operation using a memory, thereby improving adaptability (e.g. enabling variations in the number of transmission channels and subscribers.

While the invention has been shown and described with reference to certain preferred embodiments, it will be understood by those skilled in the art that various changes in form and details may be made therein without departing from the spirit and scope of the invention as defined by the appended claims.

1. An transmission apparatus four use in an optical subscriber network, the transmission apparatus comprising:
an optical line termination to receive transmission stream data, packetizing the received transmission stream data into data packets, and transmitting the data packets as optical signals; and
a plurality of optical network units connected to the optical line termination, wherein an optical network unit receives the optical signal transmitted from the optical line termination, converts the optical signal into an electrical signal, extracts transmission stream data from the converted data packet, and switches the transmission stream data to a subscriber.

2. The transmission apparatus as claimed in claim 1, wherein the transmission stream data is multi-program transmission stream data.

3. The transmission apparatus as claimed in claim 2, wherein the data link packets are high-level data link control procedure packets.

4. The transmission apparatus as claimed in claim 3, wherein the transmission apparatus is used for image data.

5. The transmission apparatus as claimed in claim 1, wherein the optical line termination comprises:
an transmission stream data receiving unit for receiving transmission stream data from an outside;
a first buffer to buffer the transmission stream data received in the transmission stream data receiving unit to convert the transmission stream data into an data packet;
a data packet generating unit for generating a data packet, which has a predetermined payload portion, from the transmission stream data stored in the buffer;
a control section for controlling the transmission stream data receiving section, the buffer and the data packet generating unit; and
an optical output unit for converting the data packet into an optical signal for transmission.

6. The transmission apparatus as claimed in claim 1, wherein an optical network unit comprises:
an transmission stream data receiving unit for receiving the optical signal from the optical line termination, converting the received optical signal into an electrical signal and outputting an data packet;
an transmission stream data extracting unit for receiving the data packet from the transmission stream data receiving unit, removing overhead from the data packet and extracting transmission stream data;
a second buffer for buffering the extracted transmission stream data a control section for controlling the transmission stream data extracting unit and the buffer; and
a switching unit for switching the transmission stream data from the second buffer to a subscriber.

7. The transmission apparatus as claimed in claim 1, wherein second buffer continuously outputs the transmission stream data.

8. The transmission apparatus as claimed in claim 6, wherein the switching unit includes a plurality of memory having assigned storage areas for each transmission stream data and subscriber, wherein the storage areas are enabled for subscriber.

9. The transmission apparatus as claimed in claim 6, wherein the subscriber access to transmission stream data is based on predetermined requirements of each subscriber.

10. The transmission apparatus as claimed in claim 4, Wherein the data packet has a predetermined size of payload.

11. The transmission apparatus as claimed in claim 5, wherein the data packet has a predetermined size of payload.

12. The transmission apparatus as claimed claim 6, wherein the data packet has a predetermined size of payload.

13. The transmission apparatus as claimed in claim 8, wherein the data packet has a predetermined size of payload.
